(19) United States
(12) Patent Application Publication
(10) Pub. No.: US 2010/0073583 A1
(43) Pub. Date: Mar. 25, 2010

(54) FLANGE STRUCTURE FOR A PORTABLE TERMINAL

(75) Inventors: Joong-Wan PARK, Suwon-si (KR); Seong-Ha Park, Suwon-si (KR); Sung-Soo Park, Suwon-si (KR); Sung-Won Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/567,235

(22) Filed: Sep. 25, 2009

(30) Foreign Application Priority Data
Sep. 25, 2008 (KR) 10-2008-0094161

(51) Int. Cl. H04N 5/64; G09G 3/36; G06F 3/041

(52) U.S. Cl. 348/794; 345/102; 345/173

(57) ABSTRACT

Disclosed is a portable terminal including a case having an opening that faces towards a user operating the terminal and a flange protruding towards the opening, a lower window having a partial surface that is attached to a lower surface of the flange, an upper window attached to the lower window to be exposed through the opening, and a liquid crystal panel placed under the lower window. The stress concentrated on and the likelihood of breakage of the flange structure of the portable terminal in which the case is connected with the window is thereby minimized.

### PRIORITY

This application claims priority under 35 U.S.C. §119(a) to a Korean Patent Application entitled “Portable Terminal” filed in the Korean Industrial Property Office on Sep. 25, 2008 and assigned Ser. No. 10-2008-0094161, the contents of which are incorporated herein by reference.

### BACKGROUND OF THE INVENTION

1. Field of the Invention

The present invention relates generally to an image display means, and more particularly to a flange structure for a portable terminal including an image display means.

2. Description of the Related Art

FIG. 1 illustrates a part assembled with an image display in a conventional portable terminal. The portable terminal 100 shown in FIG. 1 includes a case 110 having a flange 111 which protrudes to fix an image display 20. The image display 20 is mounted in the case 110 while being assembled with one end of the flange 111.

The image display 20 includes a liquid crystal panel 150, a backlight unit 160 placed under the liquid crystal panel 150, a touch screen panel 130, a window 120 attached on the touch screen panel 130, and an adhesive 140 for attaching the liquid crystal panel 150 to the touch screen panel 130.

One part of the window 120 that is in contact with the flange 111 is shaped in the manner of a stair. The window 120 includes a first part 121A being placed under the flange 111 and having a thicker width than that of a second part 121B which is not placed directly under the flange 111. That is, the second part 121B of the window 120 has a thinner width than that of the first part 121A and is assembled with the flange 111 of the case 110.

However, according to the above-mentioned structure, a stress is concentrated due to the width difference between the first part 121A and the second part 121B of the window 120, which may cause an easy breakage of the part in which the flange having the concentrated stress is assembled with the window 120.

### SUMMARY OF THE INVENTION

Accordingly, the present invention has been made to solve the above-stated problems occurring in the prior art, and an object of the present invention is to minimize the stress concentrated on and likelihood of breakage of a part of the portable terminal in which the case is connected with the window.

In accordance with an aspect of the present invention, there is provided a portable terminal including a case having an opening towards a user operating the terminal and a flange protruding towards the opening, a lower window having a partial surface that is attached to a lower surface of the flange, an upper window attached to the lower window to be exposed through the opening, and a liquid crystal panel placed under the lower window.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a portable terminal according to the prior art;

FIG. 2 illustrates a portable terminal according to a first embodiment of the present invention; and

FIG. 3 illustrates a portable terminal according to a second embodiment of the present invention.

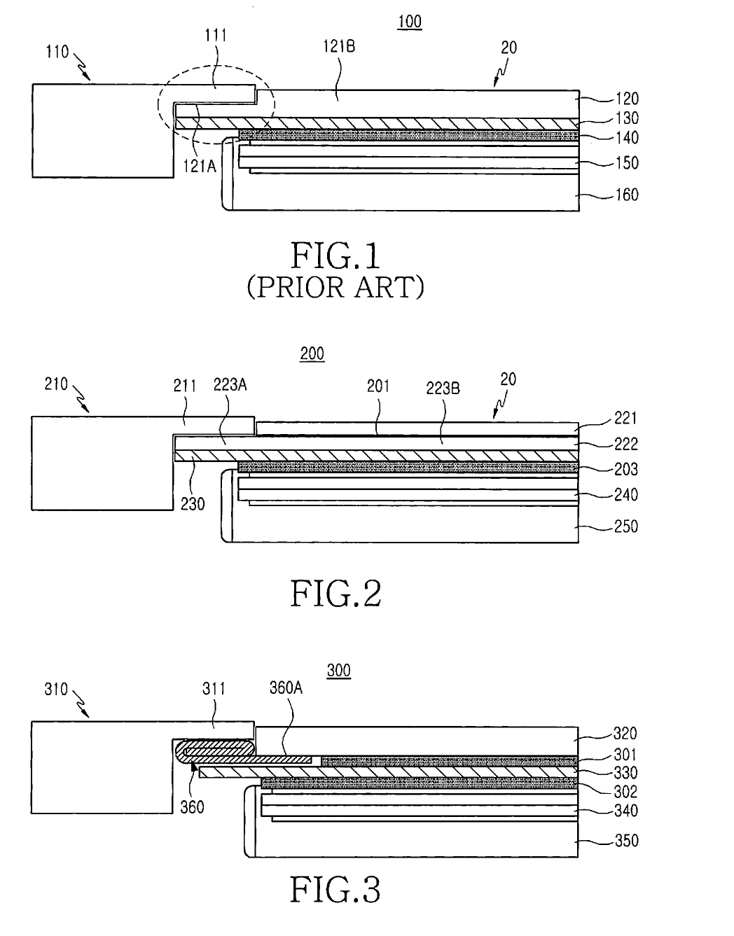

### DETAILED DESCRIPTION OF THE PREFERRED EMBODIMENTS

Hereinafter, the preferred embodiments of the present invention will be described with reference to the accompanying drawings. In the following description, detailed explanation of known related functions and constitutions may be omitted for the sake of clarity and conciseness.

FIG. 2 illustrates a portable terminal according to a first embodiment of the present invention. Referring to FIG. 2, a portable terminal 200 includes a case 210 having an opening 20 towards a user and a flange 211 protruding towards the opening 20, a lower window 222 having a partial surface that is attached to a lower surface of the flange 211, an upper window 221 attached on the lower window 222 to be exposed through the opening 20, and a liquid crystal panel 240 placed under the lower window 222.

According to the first embodiment, the lower window 222 is laminated with the upper window 221 having a size smaller than that of the lower window 222 so as to minimize the stress concentrated on the part in which the flange 211 is in contact with the lower window 222. That is, the lower window 222 is used as a stress distribution means for connecting the flange 211 and the upper window 221 with each other in such a manner that the stress concentrated on the part is minimized. The lower window 222 includes a first part 223A being placed under the flange 211 and a second part 123B which is not placed directly under the flange 211.

The upper window 221 can be made of glass and the lower window 222 can be made of glass or plastic material. The upper window 221 and lower window 222 can be attached each other by using an adhesive member 201 such as a laminating film, Optical Clear Adhesive (OCA), or ultraviolet rays resin.

A touch screen panel 230 is inserted between the lower window 222 and the liquid crystal panel 240, and the touch screen panel 230 and the liquid crystal panel 240 are attached by an adhesive 203 or other suitable attaching means well-known in the art. A backlight unit 250 can be placed under the liquid crystal panel 240.

FIG. 3 illustrates a portable terminal according to a second embodiment of the present invention. Referring to FIG. 3, the portable terminal includes a case 310 having an opening towards a user operating the terminal and a flange 311 protruding towards the opening, a window 320 inserted in the opening in which its side surface corresponds to or faces a side surface of the flange, a touch screen panel 330 placed under the window 320, an adhesive 301 for attaching the touch screen panel 330 to the window 320, a bracket 360 placed directly under the flange 311 and having an extending part 360A inserted between the touch screen panel 330 and the window 320, a liquid crystal panel 340 placed under the touch screen 330, and a backlight unit 350 placed under the liquid crystal panel 340.

The touch screen panel 330 is attached to the liquid crystal panel 340 by an adhesive 302 or other suitable attachment means well-known in the art. The bracket 360 is made of metal materials, such as Steel Use Stainless (SUS), Aluminum, Magnesium, and the extending part 360A extends so that it can be inserted between the touch screen panel 330 and the window 320.

According to the second embodiment, the window 320 and the case 310 are connected to each other using the bracket 360 so as to minimize the stress concentrated on the window 320. That is, the bracket 360 is used as a stress distribution means for connecting the flange 311 and the window 320 with each other in such a manner that the stress concentrated on the window 320 is minimized.

The conventional portable terminal has a structure vulnerable to exterior physical impact, such as being dropped, due to the flange structure being connected between the case and the image display. The window of the image display is made of plastic and the window is applied to portable terminals of various structures. The window of the image display according to the present invention does not have a discontinuous structure, and as such, the concentration of the stress to the flange of the case is minimized. Therefore, the window of the present invention is made of various materials, such as glass, and is advantageously applied to the portable terminal of various structures.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A portable terminal, comprising:
a case having a protruding flange;
a lower window having a partial surface that is attached to a lower surface of the flange;
an upper window attached on the lower window; and
a liquid crystal panel placed under the lower window.

2. The portable terminal as claimed in claim 1, further comprising a backlight unit placed under the liquid crystal panel.

3. The portable terminal as claimed in claim 2, further comprising:
a touch screen panel placed between the liquid crystal panel and the lower window; and
an adhesive member for attaching the touch screen panel to the liquid crystal panel and for attaching the touch screen panel to the lower window.

4. The portable terminal as claimed in claim 1, wherein the upper window is made of a material different from or identical to a material of the lower window.

5. The portable terminal as claimed in claim 1, wherein the upper window and the lower window are made of glass.

6. The portable terminal as claimed in claim 1, wherein the upper window is made of glass or plastic.

7. The portable terminal as claimed in claim 1, wherein the lower window is made of glass or plastic.

8. A portable terminal, comprising:
a case having an opening that faces towards a user operating the terminal and a flange protruding towards the opening;
a window inserted in the opening in which a side surface of the window faces a side surface of the flange;
a touch screen panel placed under the window;
an adhesive member for attaching the touch screen panel and the window; and
a bracket placed under the flange and having an extending part inserted between the touch screen panel and the window.

9. The portable terminal as claimed in claim 8, further comprising a liquid crystal panel placed under the touch screen.

10. The portable terminal as claimed in claim 9, further comprising a backlight unit placed under the liquid crystal panel.
